(19) United States
(12) Patent Application Publication
(10) Pub. No.: US 2011/0016075 A1
(43) Pub. Date: Jan. 20, 2011

(54) SYSTEM AND METHOD FOR CORRECTING QUERY BASED ON STATISTICAL DATA

(75) Inventors: Hee-Cheol Seo, Seoul (KR); Taeil Kim, Seoul (KR); Ji Hye Lee, Seongnam-si (KR); Hyunjung Lee, Seoul (KR)

Correspondence Address: H.C. PARK & ASSOCIATES, PLC, 8500 LEESBURG PIKE, SUITE 7500, VIENNA, VA, 22182, US

(73) Assignee: NHN CORPORATION, Seongnam-si (KR)

(21) Appl. No.: 12/837,066

(22) Filed: Jul. 15, 2010

(30) Foreign Application Priority Data
Jul. 17, 2009 (KR) 10-2009-0065337

(51) Int. Cl. G06N 5/02

(52) U.S. Cl. 706/50; 706/52

(57) ABSTRACT

A system for correcting a query includes a wrong query determination unit to determine whether an inputted query is a wrong query, a per-whole-query correction unit configured to correct the query on a per-whole-query basis, and a per-word correction unit to correct the user query on a per-word basis. A method for correcting a query includes determining whether a query is a wrong query, correcting the query on a per-whole-query basis, and correcting the query on a per-word basis.

### CROSS-REFERENCE TO RELATED APPLICATION

This application claims priority from and the benefit of Korean Patent Application No. 10-2009-0065337, filed on Jul. 17, 2009, which is hereby incorporated by reference for all purposes as if fully set forth herein.

### BACKGROUND

1. Field

Exemplary embodiments of the present invention relate to a system and method for correcting a user query based on statistical data.

2. Discussion of the Background

A user may perform a search to obtain desired information. The user may perform the search by inputting a query in a query input window of a search page. However, the user may input a wrong query by not pressing the Korean-English conversion key. Also, the user may input an excessive query by pressing a wrong key on the keyboard or by repeatedly pressing a key.

If a user performs a search by inputting a wrong query, a search result completely unrelated to an originally intended search result is derived, so that the quality of search may be decreased.

However, a system, such as a search engine may not determine the correct query intended to be originally inputted by the user. Furthermore, a correct query proposed by the system may cause an inappropriate result.

Therefore, a method that provides a correct query to reflect the user's intention and has a high accuracy may be desired.

### SUMMARY

Exemplary embodiments of the present invention provide a system and method for correcting a user query that determines whether the user query is a wrong query based on a per-whole-query basis or per-word basis.

Exemplary embodiments of the present invention also provide a system and method for correcting a user query that corrects the user query determined as a wrong query based on the per-whole-query basis or the per-word basis.

Exemplary embodiments of the present invention also provide a system and method for correcting a user query in which if a wrong query is corrected based on the per-whole-query basis, the query correction is not performed if the user query has a higher probability than a correction query corrected based on the per-whole-query basis.

Exemplary embodiments of the present invention also provide a system and method for correcting a user query in which if a wrong query is corrected based on the per-whole-query basis, the wrong query is corrected by generating candidate words for each word of the user query and determining a candidate word with a highest probability as a correction query among the candidate queries generated by combining the candidate words.

Additional features of the invention will be set forth in the description which follows, and in part will be apparent from the description, or may be learned by practice of the invention.

An exemplary embodiment provides a system for correcting a query, the system including a wrong query determination unit to determine whether the query is a wrong query, a per-whole-query correction unit to correct the query on a per-whole-query basis, and a per-word correction unit to correct the query on a per-word basis.

An exemplary embodiment provides a method that utilizes a processor to correct a query, the method including determining, using the processor, whether the query is a wrong query, correcting the query on a per-whole-query basis, and correcting the query on a per-word basis.

An exemplary embodiment provides a method that utilizes a processor to correct a query, the method including determining, using the processor, whether the query is a wrong query; correcting the query on a per-whole-query basis; and correcting the query on a per-word basis if the correcting of the query on the per-whole-query basis fails.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating the operation of a system for correcting a user query according to an exemplary embodiment of the present invention.

FIG. 2 is a block diagram illustrating a configuration of the system for correcting a user query according to an exemplary embodiment of the present invention.

FIG. 3 is a flowchart illustrating the operation of a wrong query determination unit according to an exemplary embodiment of the present invention.

FIG. 4 is a flowchart illustrating the operation of a per-whole-query correction unit according to an exemplary embodiment of the present invention.

FIG. 5 is a flowchart illustrating an operation conducted in a per-word correction unit according to an exemplary embodiment of the present invention.

FIG. 6 is a flowchart illustrating a method for generating correction candidates per word according to an exemplary embodiment of the present invention.

FIG. 7 is a diagram illustrating an example of generating a corrected query through per-word correction from a user query according to an exemplary embodiment of the present invention.

FIG. 8 is a flowchart illustrating a method for correcting a user query according to an exemplary embodiment of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

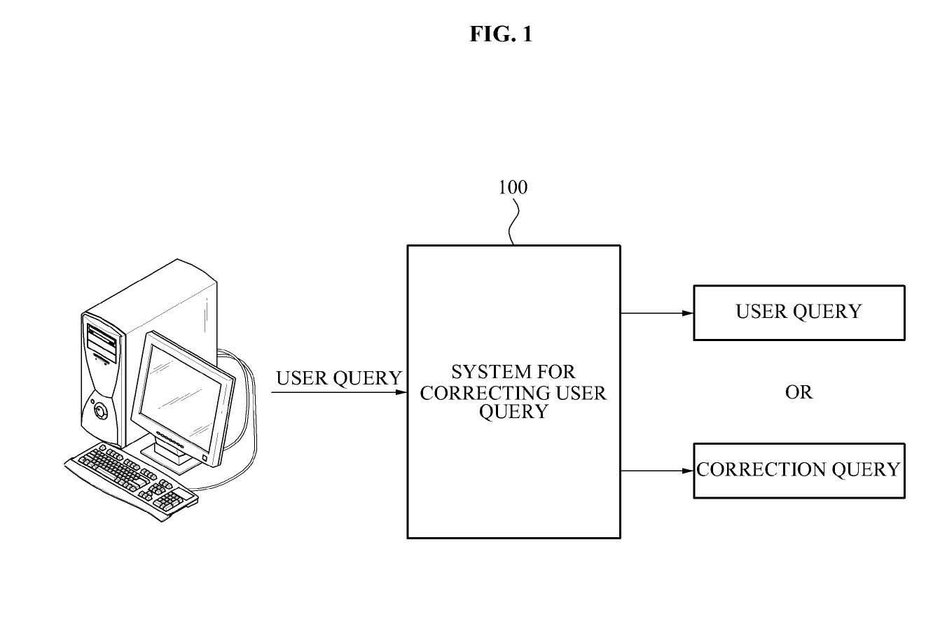

FIG. 1 is a diagram illustrating the operation of a system for correcting a user query according to an exemplary embodiment of the present invention. Referring to FIG. 1, a user may input a user query for search via a terminal, for example, a personal computer, personal digital assistant, mobile terminal, and the like. The user query may include one or more words. The inputted user query may be transmitted to the system 100. The system 100 may determine whether the inputted user query is a wrong query.

If it is determined that the user query is a wrong query, the system 100 may correct the wrong query and provide a correction query. As an example, the system 100 may correct the wrong query on a per-whole-query basis. If correction of the wrong query on the per-whole-query basis fails, the system 100 may correct the wrong query on a per-word basis. However, aspects are not limited thereto such that either of the correction of the wrong query on the per-whole-query basis or on the per-word basis may be performed initially.

Although the system 100 generates a correction query by correcting the wrong query, the user may prefer the initially inputted user query to the correction query. Thus, the is system 100 may provide the user query as a result rather than the correction query.

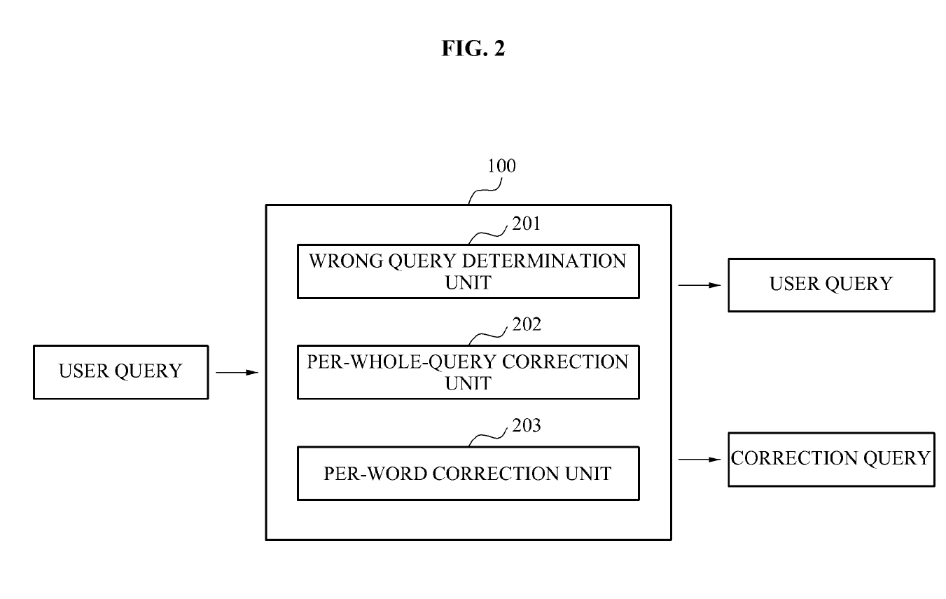

FIG. 2 is a block diagram illustrating a configuration of the system for correcting a user query according to an exemplary embodiment of the present invention. Referring to FIG. 2, the system 100 may include a wrong query determination unit 201, a per-whole-query correction unit 202, and a per-word correction unit 203.

Terms used hereinafter are defined as follows.

A user query refers to a query inputted by a user. The user query may include a word or a set of words inputted when the user searches for or writes a document.

A wrong query refers to a query generated when the Korean-English conversion key is not pressed by a user, when a wrong key is inputted by the user, and the like. Various cases may exist where a wrong query is generated.

A dictionary data including wrong-correct query pairs refers to data including correction queries respectively corresponding to wrong queries. The wrong query may include spaces, and the correct query may include spaces as they are. An example of the dictionary data including wrong-correct query pairs is as follows in Table 1.

TABLE 1

| Wrong query | Correct query |
|---|---|
| [symbol] | [symbol] |
| [symbol] | [symbol] |
| [symbol] | [symbol] |
| [symbol] | [symbol] |

The dictionary data having correct words may refer to data including correct words. As an example, the correct words may be extracted from data having a very high accuracy, such as a Korean-language dictionary or an encyclopedia. The dictionary data including wrong-correct query pairs provides correct queries with respect to some or all wrong queries. Alternatively, the dictionary data including correct words may provide correct words respectively corresponding to words of the wrong query.

The wrong query determination unit 201 may determine whether a user query inputted by a user is a wrong query. As an example, the wrong query determination unit 201 may include a first determination unit (not shown) and a second determination unit (not shown).

According to an exemplary embodiment, the first determination unit of the wrong query determination unit 201 may determine whether the user query is a wrong query on a per-whole-query basis. The first determination unit may search the user query from dictionary data including wrong-correct query pairs and then determine whether the user query is a wrong query on the per-whole-query basis.

That is, the first determination unit of the wrong query determination unit 201 may search whether the whole user query exists in the dictionary data including wrong-correct query pairs and then determine whether the user query is a wrong query. If the user query has two or more words, the first determination unit may search the dictionary data while maintaining spaces between the words.

According to an exemplary embodiment, the second determination unit of the wrong query determination unit 201 may determine whether the user query is a wrong query on a per-word basis. The second determination unit may search words of the user query from dictionary data including correct words and then determine whether the user query is a wrong query on the per-word basis. That is, the second determination unit may determine whether the user query is a wrong query by comparing the respective words of the user query with the correct words.

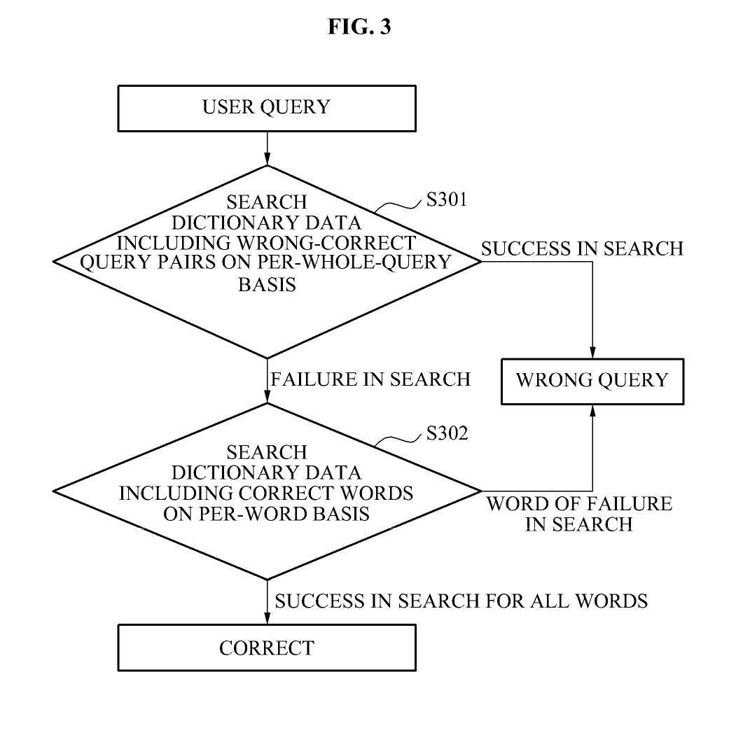

The wrong query determination unit 201 will later be further described with reference to FIG. 3.

The per-whole-query correction unit 202 may correct the user query determined as the wrong query on the per-whole-query basis. That is, the per-whole-query correction unit 202 may generate a correction query with respect to the whole user query. As an example, the per-whole-query correction unit 202 may include a registration determination unit (not shown) and a probability calculation unit (not shown).

According to an exemplary embodiment, the registration determination unit of the per-whole-query correction unit 202 may determine whether the user query is registered as a wrong query in the dictionary data including wrong-correct query pairs. If the user query is not registered as a wrong query in the dictionary data, the correction of the wrong query is processed as a failure.

If the user query is registered as a wrong query in the dictionary data, the probability calculation unit of the per-whole-query correction unit 202 may calculate the probability of each of the correct query and the wrong query based on the dictionary data including wrong-correct query pairs. The calculated probability may indicate whether the correct query based on the dictionary data is suitable for search or whether the initially inputted user query is suitable for search. The probability calculation unit may calculate a syllable conversion probability based on different syllables between the user query and the correct query.

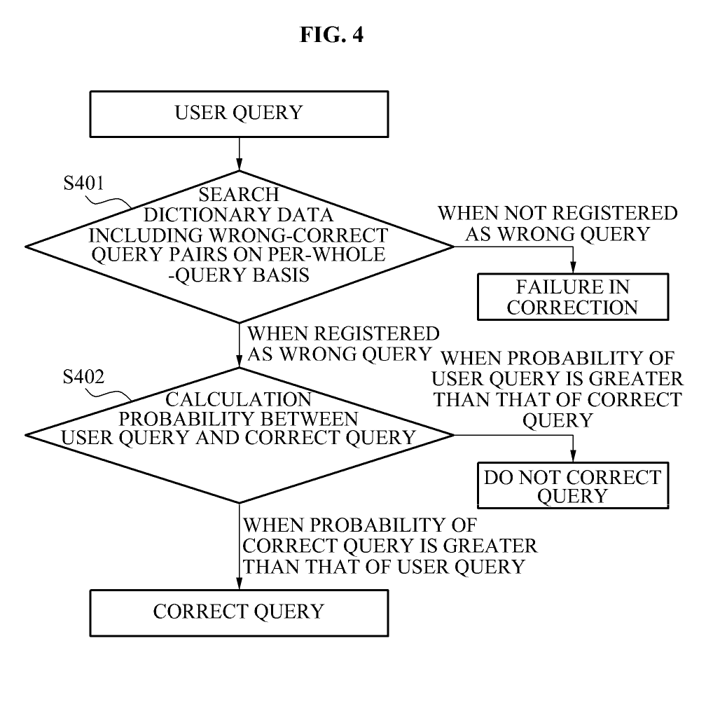

The probabilities described herein may indicate which query is more suitable between the user query and the correct query. If the probability of the user query is greater than is the probability of the correct query, the query correction on the per-whole-query basis may be completed. In contrast, if the probability of the correct query is greater than the probability of the user query, the correct query may be determined as the correction query. The per-whole-query correction unit 202 will later be further described with reference to FIG. 4.

The per-word correction unit 203 may correct the user query determined as the wrong query for each word of the user query. According to an exemplary embodiment, the per-word correction unit 203 may include a word separation unit (not shown), a candidate word generation unit (not shown), and a correction query determination unit (not shown).

The word separation unit of the per-word correction unit 203 may separate the user query into at least one word, or if the user query is only one word, the word separation unit may use the entire one word. The word separation unit may separate the user query into at least one word for each space included in the user query. For example, if the user query is configured as “A B C”, the word separation unit may separate the user query into A, B, and C on a per-space basis.

The candidate word generation unit of the per-word correction unit 203 may generate a correction candidate word for each of the separated words. According to an exemplary embodiment, the candidate word generation unit may include a first search unit (not shown), a second search unit (not shown), and a candidate word extraction unit (not shown).

The first search unit of the candidate word generation unit may search a separated word from the dictionary data including correct words. If the word search fails in the first search unit, the second search unit of the candidate word generation unit may search for a separated word from the dictionary data including wrong-correct query pairs. If the word search fails in the second search unit, the candidate word extraction unit of the candidate word generation unit is may extract a candidate word based on a Korean-English conversion or a correction candidate word based on a syllable conversion rule. If the word search succeeds in both of the first and second search units, the searched word may be identified a correction candidate word.

The correction query determination unit of the per-word correction unit 203 may determine a correction query with respect to the user query based on the correction candidate word generated by the candidate word generation unit. As an example, the correction query determination unit may determine an optimal correction query by combining correction query words including words of the user query. The correction query determination unit may determine a candidate query with a highest probability among the candidate queries generated by combining the words of the user query and the correction candidate words.

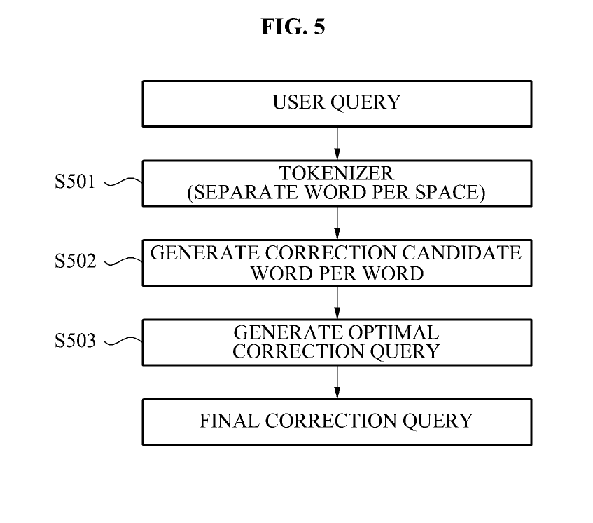

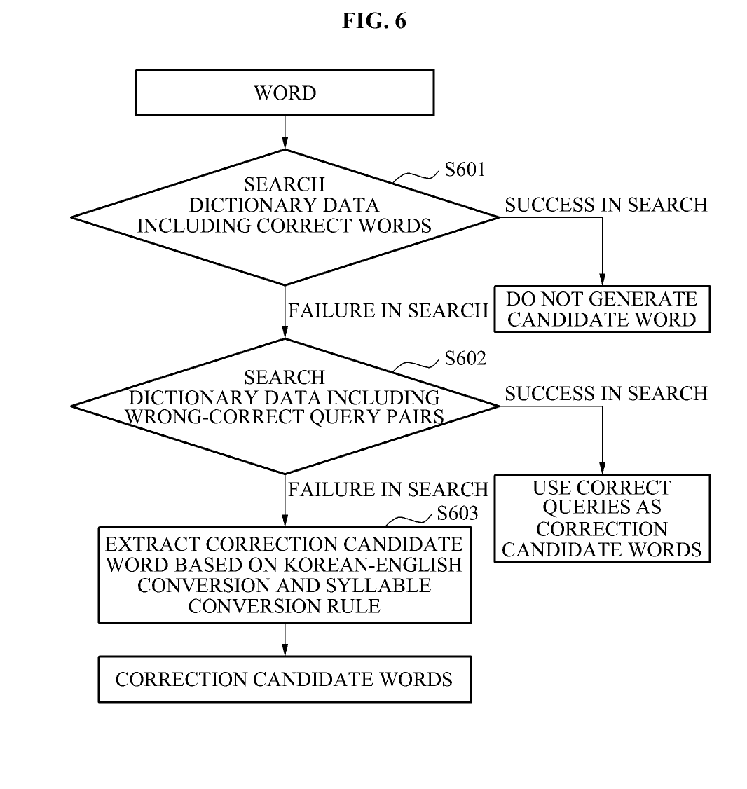

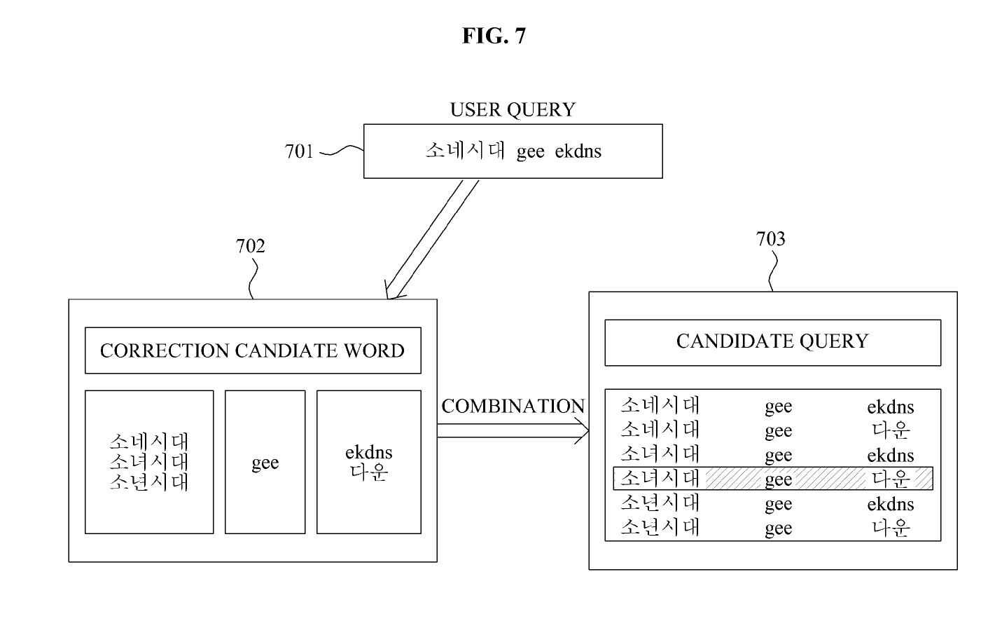

The per-word correction unit 203 will later be further described with reference to FIG. 5, FIG. 6, and FIG. 7.

FIG. 3 is a flowchart illustrating the operation of a wrong query determination unit according to an exemplary embodiment of the present invention. For example, the wrong query determination unit may be the wrong query determination unit 201 as described above with respect to FIG. 2. The wrong query determination unit 201 may determine whether the inputted user query is a wrong query. Specifically, the wrong query determination unit may search for the user query in dictionary data including wrong-correct query pairs on a per-whole-query basis in operation S301. For example, if the user query is inputted as [symbol] and [symbol] - [symbol] is included in the dictionary data including wrong-correct query pairs, the wrong query determination unit 201 may determine the user query as a wrong query.

If the user query has two or more words, the wrong query determination unit 201 is may search for the user query in the dictionary data including wrong-correct query pairs while maintaining spaces between the words.

If the search fails in operation S301, the wrong query determination unit 201 may search for the user query in dictionary data including correct words on a per-word basis in operation S302. The wrong query determination unit 201 may search some or all of the words of the user query from the dictionary data.

If all of the words of the user query are found in the dictionary data, the wrong query determination unit 201 may determine the user query as a correct query. In contrast, if a word of the user query is not found in the dictionary data is in the words of the user query, the wrong query determination unit 201 may determine the user query as a wrong query.

For example, if the user query is [symbol] and all of the words of the user query exist in the dictionary data including correct words, the wrong query determination unit 201 may determine the user query as a correct query. Alternatively, if the user query is [symbol] [symbol] , [symbol] is registered in the dictionary data, and [symbol] is not registered in the dictionary data, the wrong query determination unit 201 may determine the [symbol] as a wrong query.

FIG. 4 is a flowchart illustrating the operation of a per-whole-query correction unit according to an exemplary embodiment of the present invention. For example, the per-whole-query correction unit may be the per-whole-query correction unit 202 as described above with respect to FIG. 2. The per-whole-query correction unit 202 may correct the user query determined as a wrong query on a per-whole-query basis.

The per-whole-query correction unit 202 may search the user query from dictionary data including wrong-correct query pairs and determine whether the user query is is registered as the wrong query in operation S401.

If the user query is not registered as a wrong query, the per-whole-query correction unit 202 processes the correction of the user query on the per-whole-query basis as a failure. In contrast, if the user query is registered as a wrong query, the per-whole-query correction unit 202 may calculate the probability of each of the correct query and the user query based on the dictionary data including wrong-correct query pairs in operation S402. That is, if the whole user query is registered in the dictionary data as a wrong query, the per-whole-query correction unit 202 may perform the correction of the user query on the per-whole-query basis and may determine the correct query as the correction query.

If the probability of the correct query is greater than the probability of the user query, the per-whole-query correction unit 202 may determine the correct query as a correction query on the per-whole-query basis with respect to the user query. If the probability of the user query is greater than the probability of the correct query, the per-whole-query correction unit 202 may complete the query correction and not correct the user query. The probability indicates which query is more suitable between the user query and the correct query.

For example, if [symbol] is inputted as a user query, it is assumed that [symbol] - [symbol] is included in dictionary data as a wrong-correct query pair. If [symbol] is, for example, on sale, it may be a more suitable query than [symbol] Thus [symbol] , which is a correct query, may have a lower probability than the

[symbol]

[symbol]

According to an exemplary embodiment, the per-whole-query correction unit 202 may calculate a syllable conversion probability based on different syllables between the user queries and the correct the queries. As an example, the probability between the correct queries and the user queries may be determined by the following Expression 1.

$$- Probability of correct query \text{:} \\ {P ( Q -> {Q}^{′} )}^{def} = P ( {Q}^{′} ) P 〈 {Q}^{′} \vert Q 〉 \\ - Probability of user query \text{:} \\ \begin{matrix}\begin{matrix}P {( Q -> Q )}^{def} = P ( Q ) P 〈 Q \vert Q 〉 = P ( Q ) \\ P ( {Q}^{′} ) = P ( {q}_{0 , n}^{′} ) \approx {\prod }_{i = 1}^{n} P 〈 {q}_{i}^{′} \vert {q}_{i - 1}^{′} 〉\end{matrix} \\ P 〈 {Q}^{′} \vert Q 〉 = P 〈 {q}_{1 , n}^{′} \vert {q}_{1 , n} 〉 \approx {\prod }_{i = 1}^{n} P 〈 {q}_{i}^{′} \vert {q}_{i} 〉\end{matrix} \qquad [ Expression 1 ]$$

Q denotes a user query, and Q′ denotes a correct query corrected through the dictionary data including wrong-correct query pairs. The syllable conversion probability may be used for P(q′ᵢ|qᵢ). P(Q′|Q) may refer to a probability that a user will realize that a wrong query is recognized as a correct query and then correct the wrong query into the correct query. Alternatively, the P(Q′|Q) may refer to a probability that a user will realize that a user query is inputted as a wrong query and then input a correct query.

The P(Q′|Q) may be replaced with P(Q|Q′). The P(Q|Q′) may be interpreted as a probability that, although the user recognizes a user query as a correct query, a wrong query will be generated in the process of typing the user query.

If a conversion probability is evaluated with all the words of the user query, there may be insufficient data. As the number of words is increased, the amount of calculation may be rapidly increased. According to an exemplary embodiment, the per-whole-query correction unit 202 may calculate a syllable conversion probability with respect to different syllables between the user query and the correct query.

As an example, the P(q′ᵢ|qᵢ) in Expression 1 may be determined by the following Expression 2.

$$P 〈 {q}_{i}^{′} \vert {q}_{i} 〉 = {\prod }_{j = 1}^{k} P 〈 {q}_{ij}^{′} \vert {q}_{ij} 〉 = {\prod }_{j = 1 , {q}_{ij}^{′} \neq {q}_{ij}}^{k} P 〈 {q}_{ij}^{′} \vert {q}_{ij} 〉 \qquad [ Expression 2 ]$$

In Expression 2, P(q′ᵢⱼ|qᵢⱼ) denotes a conversion probability between syllables. The per-whole-query correction unit 202 performs division with respect to different syllables between words qᵢⱼ and q′ᵢⱼ. In Expression 2, it is assumed that two divisions are performed. Then, the per-whole-query correction unit 202 may calculate a probability with respect to different syllables from the divided result. For example, if the user query is abcd and the correct query is abed, the conversion probability between syllables P(abed|abcd) becomes P(a|a)P(b|b)P(c|e)P(d|d)=P(c|e).

As an example, the conversion probability between syllables may be calculated through the following process, using QC (input frequency of user query) and QQ (input frequency of user-correct query pair).

(1) QC and QQ are provided to each wrong-correct query pair included in the dictionary data. For example, abcd(qc:10)-abed(qc:100), qq:5.

(2) A different partial character string (c-e) is determined in the wrong-correct query pair.

(3) The frequency of the partial character string is calculated. Specifically, the sum of qc and qq is calculated with respect to all wrong-correct query pairs having the c-e pair shown in the dictionary data. For example, c(qc:50)-e(qc:1000), qq:20.

(4) The syllable conversion probability is calculated using the calculated frequency.

P(c|e)=20/50

FIG. 5 is a flowchart illustrating an operation conducted in a per-word correction unit according to an exemplary embodiment of the present invention. The per-word correction unit may be, for example, the per-word correction unit 203 as described above with respect to FIG. 2. The per-word correction unit 203 may separate, for example, via a tokenizer, a user query into at least one word in operation S501. The per-word correction unit 203 may separate the user query into at least one word per space included in the user query. For example, if the user query is configured as “A B C”, the per-word correction unit 203 may separate the user query into “A”, “B”, and “C”.

The per-word correction unit 203 may generate a correction candidate word for each of the separated words in operation S502. For example, the per-word correction unit 203 may first search words separated from dictionary data including correct words. If the first search fails, the per-word correction unit 203 may search a separated word in dictionary data including wrong-correct query pairs in a second search. If the second search also fails, the per-word correction unit 203 may extract a candidate word based on a Korean-English conversion and/or a correction candidate word based on a syllable conversion rule in a third search and/or a fourth search. However, aspects are not limited thereto such that the first, second, third, and fourth searches may be performed in other orders and each of the first, second, third, and fourth searches need not be performed, i.e., only the first, third, and fourth searches may be performed in some aspects. Operation S502 will later be further described with reference to FIG. 6 and FIG. 7.

The per-word correction unit 203 may determine a final correction query with respect to the user query based on the generated correction candidate word in operation S503. That is, the per-word correction unit 203 may generate an optimal correction query on the per-word basis from the user query.

FIG. 6 is a flowchart illustrating a method for generating correction candidates per word according to an exemplary embodiment of the present invention. The per-word correction unit 203 may receive a separated word and search dictionary data including correct words for the received separated word in operation S601. If the search succeeds and the received separated word is found in the dictionary data including correct words, the per-word correction unit 203 may determine the received separated word as a correction candidate word, as opposed to separately generating a correction candidate word.

If the search fails and the received separated word is not found in the dictionary data including correct words, the per-word correction unit 203 may search for the received separated word separated in dictionary data including wrong-correct query pairs in operation S602. If the search succeeds and the received separated word is found in the dictionary data including wrong-correct query pairs, the per-word correction unit 203 may determine the correct query as a correction candidate word.

In contrast, if the search fails the received separated word is not found in the dictionary data including wrong-correct query pairs, the per-word correction unit 203 may extract a correction candidate word based on a Korean-English conversion and/or a correction candidate word based on a syllable conversion rule in operation S603.

As an example, the correction candidate word based on the Korean-English conversion may refer to a candidate word for correcting a wrong word inputted if a user does not press a Korean-English conversion key. For example, if the user inputs “ekdns”, the per-word correction unit 203 may extract [symbol] as a correction candidate word. if the user inputs “cnrrn”, the per-word correction unit 203 may extract [symbol] as a correction candidate word.

In contrast, if the user inputs [symbol] , the per-word correction unit 203 may extract “June” as a correction candidate word. If the user inputs [symbol] , the per-word correction unit 203 may extract “pairs” as a correction candidate word.

For example, the correction candidate word based on the syllable conversion rule may refer to a candidate word for correcting a wrong word inputted if a user repeatedly inputs a syllable or if the user inputs a wrong key. The syllable conversion rule may refer to a rule that generates a candidate word by analyzing a user error pattern and that converts syllables frequently miswritten by a user. For example, the per-word correction unit 203 may generate a candidate word in consideration of adjacent syllables. For example, [symbol] → [symbol] [symbol] → [symbol] , and [symbol] → [symbol] may be extracted as correction candidate words based on the syllable conversion rule.

FIG. 7 is a diagram illustrating an example of generating a corrected query through per-word correction from a user query according to an exemplary embodiment of the present invention.

The per-word correction unit 203 may determine an optimal correction query by combining correction candidate words including words of a user query. The per-word correction unit 203 may determine a candidate query with a highest probability as a correction query among the candidate queries generated by combining the words of the user query and the correction candidate words. For example, the probability of the candidate query may be rapidly calculated by a Viterbi algorithm.

Referring to FIG. 7, for example, [symbol] gee ekdns” is inputted as a user query 701. The per-word correction unit 203 may separate the user query 701 and then extract correction candidate words 702 with respect to the separated words. In FIG. 7, the correction candidate word 702 for [symbol] may be determined as [symbol] , [symbol] , or [symbol] . Also, the correction candidate word 702 for “ekdns” may be determined as “ekdns” or

[symbol]

The per-word correction unit 203 may generate candidate queries 703 by combining the words of the user query and the correction candidate words 702. In FIG. 7, six candidate queries 703 may be generated with respect to the user query 701. The per-word correction unit 203 may determine the [symbol] gee [symbol] as having the highest probability such that the [symbol] gee [symbol] is determined as a correction query among the six candidate queries 703.

For example, the probability of each of the candidate queries 703 may be determined by Expression 1 and Expression 2. Expression 1 and Expression 2 are applied to the example of FIG. 7 as follows.

P( [symbol] gee ekdns→ [symbol] gee [symbol] =P( [symbol] gee [symbol] )P( [symbol] gee ekdns| [symbol] gee

[symbol]

P( [symbol] gee [symbol] =P( [symbol] ̂)P(gee| [symbol] )P( [symbol] gee)

P( [symbol] gee [symbol] gee ekdns) =P( [symbol] [symbol] )P(gee|gee)P( [symbol] ekdns)

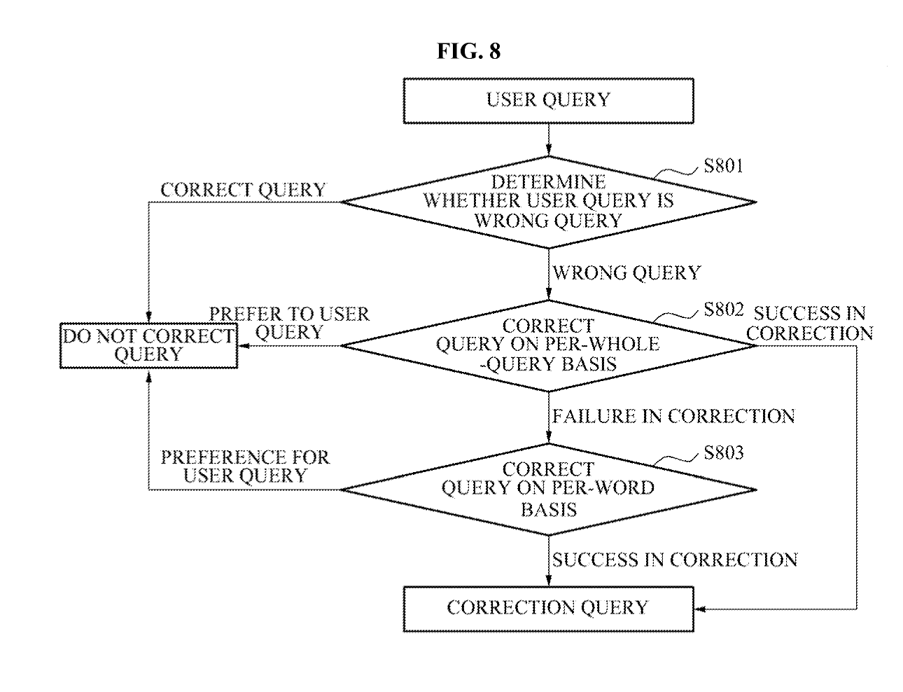

FIG. 8 is a flowchart illustrating a method for correcting a user query according to an exemplary embodiment of the present invention. The system may receive an inputted user query and determine whether the inputted user query is a wrong query in operation S801.

For example, the system may determine whether the user query is a wrong query on a per-whole-query basis. The system may search for the user query in dictionary data including wrong-correct query pairs and determine whether the user query is a wrong query on the per-whole-query basis. If the user query has two or more words, the system may search the dictionary data while maintaining spaces between the words.

If the search for the user query in the dictionary data including wrong-correct query pairs fails, the system may search for the words of the user query in dictionary data including correct words and determine whether the user query is a wrong query on a per-word basis. However, the search for the words of the user query in the dictionary data including the correct words may be performed before the search for the user query in the dictionary data including wrong-correct query pairs.

The system may correct the user query determined as the wrong query on the per-whole-query basis in operation S802.

For example, the system may determine whether the user query is registered as a wrong query in the dictionary data including wrong-correct query pairs.

If the user query is registered as a wrong query in the dictionary data, the system may calculate a probability for each of the correct query and the user query based on the dictionary data including wrong-correct query pairs. The system may calculate a syllable conversion probability based on different syllables between the user query and the correct query.

For example, if the probability of the correct query is greater than the probability of the user query, the system may determine the correct query as a correction query. In contrast, if the probability of the correct query is smaller than the probability of the user query, the system may complete the query correction on the per-whole-query basis. That is, if the user prefers the user query to the correct query, the query correction may not be performed.

If the query correction on the per-whole-query basis fails, the system may correct the user query determined as the wrong query on the per-word basis in operation S803. However, aspects are not limited thereto such that the system may perform the correction of the query on the per-word basis before the correction of the query on the per-whole-query basis.

For example, the system may separate the user query into at least one word. The system may separate the user query into the at least one word per space included in the user query.

Then, the system may generate correction candidate words for each of the separated words. The system may search the separated words from the dictionary data including correct words. If the search succeeds, the correct query may be a correction query.

If the search fails, the system may search for the separated words in the dictionary data including wrong-correct query pairs. If the search of the separated words in the dictionary data including wrong-correct query pairs succeeds, the correct query may be a correction query.

If the search of the separated words in the dictionary data including wrong-correct query pairs fails, the system may extract a candidate word based on a Korean-English conversion and/or a correction candidate word based on a syllable conversion rule. Then, the system may determine a correction query with respect to the user query based on the generated correction candidate words. The system may determine an optimal correction query by combining correction candidate words including the words of the user query. For example, the system may determine a candidate query with the highest probability as a correction query among the candidate queries generated by combining the words of the user query and the correction candidate words.

Parts that are not described in FIG. 8 may be understood by referring to descriptions of FIGS. 1 to 7.

The method according to the embodiment of the present invention may include non-transitory computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of non-transitory computer-readable media include magnetic media such as hard disks, floppy disks, and magnetic tape; optical media such as CD ROM disks and DVD; magneto-optical media such as floptical disks; and hardware devices that are specially configured to store and perform program instructions, such as read-only memory (ROM), random access memory (RAM), flash memory, and the like, and combinations thereof. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. A system for correcting a query, the system comprising:
a wrong query determination unit to determine whether the query is a wrong query;
a per-whole-query correction unit to correct the query on a per-whole-query basis; and
a per-word correction unit to correct the query on a per-word basis.

2. The system of claim 1, wherein the wrong query determination unit comprises:
a first determination unit to determine whether the query is a wrong query on the per-whole-query basis; and
a second determination unit to determine whether the query is a wrong query on the per-word basis.

3. The system of claim 2, wherein the first determination unit searches for the query in dictionary data including wrong-correct query pairs.

4. The system of claim 3, wherein, if the query has two or more words, the first determination unit searches the dictionary data while maintaining spaces between the two or more words of the query.

5. The system of claim 2, wherein the second determination unit searches for words of the query in dictionary data including correct words.

6. The system of claim 1, wherein the per-whole-query correction unit comprises:
a registration determination unit to determine whether the query is registered as a wrong query in the dictionary data including wrong-correct query pairs; and
a probability calculation unit to calculate a probability for each of the query and the correct query based on the dictionary data including wrong-correct query pairs.

7. The system of claim 6, wherein the probability calculation unit calculates a syllable conversion probability based on different syllables between the query and the correct query.

8. The system of claim 6, wherein the per-whole-query correction unit determines the correct query as a correction query if the probability of the correct query is greater than the probability of the query, and completes the query correction on the per-whole-query basis if the probability of the correct query is smaller than that of the query.

9. The system of claim 1, wherein the per-word correction unit comprises:
a word separation unit to separate the query into at least one word;
a candidate word generation unit to generate correction candidate words for each of the separated words; and
a correction query determination unit to determine a correction query with respect to the query based on the generated correction candidate words.

10. The system of claim 9, wherein the word separation unit separates the query into the at least one word per space included in the query.

11. The system of claim 9, wherein the candidate word generation unit comprises:
a first search unit to search for the separated word in dictionary data including correct words;
a second search unit to search for the separated word in dictionary data including wrong-correct query pairs; and
a candidate word extraction unit to extract a candidate word based on a Korean-English conversion or a correction candidate word based on a syllable conversion rule.

12. The system of claim 9, wherein the correction query determination unit determines a correction query by combining the correction candidate words, the correction candidate word including words of the query.

13. The system of claim 12, wherein the correction query determination unit determines a candidate query with a highest probability as the correction query among the candidate queries generated by combining the words of the query and the correction candidate words.

14. A method that utilizes a processor to correct a query, the method comprising:
determining, using the processor, whether the query is a wrong query;
correcting the query on a per-whole-query basis; and
correcting the query on a per-word basis.

15. The method of claim 14, wherein the determining of the query comprises:
determining whether the query is a wrong query on the per-whole-query basis; and
determining whether the query is a wrong query on the per-word basis.

16. The method of claim 15, wherein the correcting of the query determined as the wrong query on the per-whole-query basis comprises searching for the query in dictionary data including wrong-correct query pairs.

17. The method of claim 16, wherein, if the query has two or more words, the correcting of the query determined as the wrong query on the per-whole-query basis comprises searching in the dictionary data while maintaining spaces between words of the query.

18. The method of claim 15, wherein the correcting of the query on the per-word basis comprises searching for words of the query in dictionary data including correct words.

19. The method of claim 14, wherein the correcting of the query on the per-whole-query basis comprises:
determining whether the query is registered as a wrong query in dictionary data including wrong-correct query pairs; and
calculating a probability for each of the query and the correct query based on the dictionary data including wrong-correct query pairs.

20. The method of claim 19, wherein the calculating of the probability for each of the query and the correct query based on the dictionary data including wrong-correct query pairs comprises calculating a syllable conversion probability based on different syllables between the query and the correct query.

21. The method of claim 19, wherein the correcting of the query on the per-whole-query basis comprises:
determining the correct query as a correction query if the probability of the correct query is greater than that of the query; and
completing the query correction on the per-whole-query basis if the probability of the correct query is smaller than that of the query.

22. The method of claim 14, wherein the correcting of the query determined as the wrong query on the per-word basis comprises:
separating the query into at least one word;
generating correction candidate words for each of the separated words; and
determining a correction query for the query based on the generated correction candidate words.

23. The method of claim 22, wherein the separating the query into the at least one word comprises separating the query into the at least one word per space included in the query.

24. The method of claim 22, wherein the generating the correction candidate words for each of the separated words comprises:
searching for the separated words in dictionary data including correct words;
searching for the separated words in dictionary data including wrong-correct query pairs; and
extracting candidate words based on a Korean-English conversion or correction candidate words based on a syllable conversion rule.

25. The method of claim 22, wherein the determining of the correction query with respect to the query based on the generated correction candidate words comprises determining a correction query by combining the correction candidate words, the correction candidate word including words of the query.

26. The method of claim 25, wherein the determining of the correction query with respect to the query based on the generated correction candidate words comprises determining a candidate query with a highest probability as the correction query among the candidate queries generated by combining the words of the query and the correction candidate words.

27. A non-transitory computer-readable medium in which a program for performing the method of claim 14 is recorded.

28. A method that utilizes a processor to correct a query, the method comprising:
determining, using the processor, whether the query is a wrong query;
correcting the query on a per-whole-query basis; and
correcting the query on a per-word basis if the correcting of the query on the per-whole-query basis fails.
